(19) United States
(12) Patent Application Publication
(10) Pub. No.: US 2006/0268209 A1
(43) Pub. Date: Nov. 30, 2006

(54) Transmission liquid crystal display operable in optically compensated bend mode

(75) Inventors: I-An Yao, Miao-Li (TW); Pin-Fa Wang, Miao-Li (TW); Chiu-Lien Yang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/443,538

(22) Filed: May 30, 2006

(30) Foreign Application Priority Data
May 28, 2005 (CN) 200510034946.0

(51) Int. Cl. G02F 1/1335

(52) U.S. Cl. 349/119

(57) ABSTRACT

An exemplary transmission liquid crystal display (100) includes a first glass substrate (110) and a second glass substrate (120); a liquid crystal layer (130) having liquid crystal molecules interposed between the first and second substrates, the liquid crystal molecules being bend-aligned whereby the liquid crystal display device to operate in an optically compensated bend (OCB) mode; a front polarizer (171) disposed at a front surface of the first substrate, a rear polarizer (172) disposed at a rear surface of the second substrate; a first compensation member (180) between the front polarizer and the first substrate; and a second compensation member (190) between the rear polarizer and the second substrate.

### FIELD OF THE INVENTION

The present invention relates to transmission liquid crystal displays (LCDs), and more particularly to transmission LCDs that operate in OCB (optically compensated bend) mode.

### BACKGROUND

Recently, LCDs that are light and thin and have low power consumption characteristics have been widely used in office automation equipment, video units and the like.

As shown in FIG. 12, a conventional transmission liquid crystal display 1 includes a first substrate 10, a second substrate 20 opposite to the first substrate 10, and a liquid crystal layer 30 interposed between the first and second substrates 10, 20. A front polarizer 71 and a front retardation film 80 are disposed on an outer surface of the first glass substrate 10, in that order from top to bottom. A front alignment film 61, a common electrode 51, and a color filter 40 are disposed on an inner surface of the first substrate 10, in that order from bottom to top. A pixel electrode 52 is laminated on an inner surface of the second substrate 20. A rear alignment film 62 is laminated on the pixel electrode 52. A rear retardation film 90 and a rear polarizer 72 are disposed on an outer surface of the second substrate 20, in that order from top to bottom. A backlight module (not shown) is provided under the rear polarizer 72.

The front retardation film 80 and the rear retardation film 90 are quarter-wavelength plates. The liquid crystal molecules of the liquid crystal layer 30 are homogeneously aligned. An absorption axis of the front polarizer 71 is orthogonal to that of the rear polarizer 72. Anchoring energy exists between the alignment films 61, 62 and certain of the liquid crystal molecules adjacent to the alignment films 61, 62. Therefore when an electrical field is applied, these liquid crystal molecules need an unduly long amount of time to become oriented according to the applied electrical field. This typically results in residual images being produced.

What is needed, therefore, is a liquid crystal display device which has a fast response time.

### SUMMARY

In a preferred embodiment, a transmission LCD device includes a first glass substrate and a second glass substrate; a liquid crystal layer having liquid crystal molecules interposed between the first and second substrates, the liquid crystal molecules being bend-aligned whereby the liquid crystal display device to operate in an optically compensated bend (OCB) mode; a front polarizer disposed at a front surface of the first substrate, a rear polarizer disposed at a rear surface of the second substrate; a first compensation member between the front polarizer and the first substrate; and a second compensation member between the rear polarizer and the second substrate.

Further, the transmission LCD device preferably includes a first front compensation film and a second front compensation film. Preferably, the first front compensation film is a hybrid C-compensation film.

According to other embodiments, the transmission LCD device preferably includes a first rear compensation film and a second rear compensation film; and the first rear compensation film is a C-compensation film.

Other advantages and novel features will become more apparent from the following detailed description when taken in conjunction with the accompanying drawings, in which:

### BRIEF DESCRIPTION OF THE DRAWINGS

FIG. 1 is a schematic, exploded, side cross-sectional view of a transmission LCD according to a first preferred embodiment of the present invention;

FIG. 2 is a schematic, exploded, side cross-sectional view of a transmission LCD according to a second preferred embodiment of the present invention;

FIG. 3 is a graph illustrating contrast ratio characteristics of the transmission LCD of FIG. 2, when light is incident and received at a predetermined wavelength;

FIG. 4 is a graph illustrating gray scale performance along a horizontal direction of the transmission LCD of FIG. 2, when different voltages are applied;

FIG. 5 is a graph illustrating gray scale performance along a vertical direction of the transmission LCD of FIG. 2, when different voltages are applied;

FIG. 6 is a schematic, exploded, side cross-sectional view of a transmission LCD according to a third preferred embodiment of the present invention;

FIG. 7 is a schematic, exploded, side cross-sectional view of a transmission LCD according to a fourth preferred embodiment of the present invention;

FIG. 8 is a schematic, exploded, side cross-sectional view of a transmission LCD according to a fifth preferred embodiment of the present invention;

FIG. 9 is a graph illustrating contrast ratio characteristics of the transmission LCD of FIG. 8, when light is incident and received at a predetermined wavelength;

FIG. 10 is a graph illustrating gray scale performance along a horizontal direction of the transmission LCD of FIG. 8, when different voltages are applied;

FIG. 11 is a graph illustrating gray scale performance along a vertical direction of the transmission LCD of FIG. 8, when different voltages are applied; and

FIG. 12 is a schematic, exploded, side cross-sectional view of a conventional transmission LCD.

### DETAILED DESCRIPTION OF PREFERRED EMBODIMENTS

In this description, unless the context indicates otherwise, a reference to a compensation member is a reference to a kind of optical compensation member.

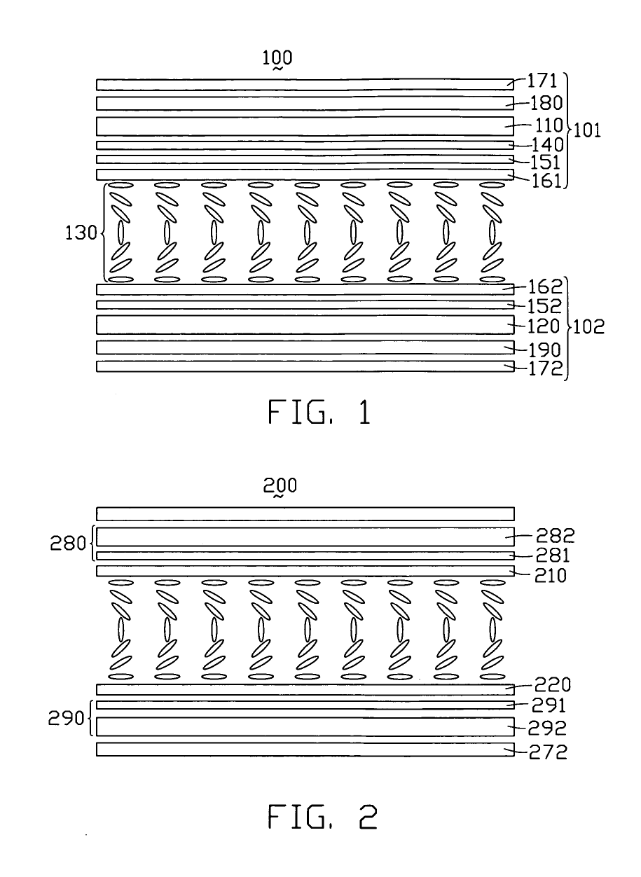

FIG. 1 is a schematic, exploded, side cross-sectional view of a transmission LCD 100 according to a first preferred embodiment of the present invention. The transmission LCD 100 includes a first substrate assembly 101, a second substrate assembly 102 opposite to the first substrate assembly 101, and a liquid crystal layer 130 interposed between the first and second substrate assemblies 101, 102.

The first substrate assembly 101 includes a front polarizer 171, a front compensation member 180, a first glass substrate 110, a color filter 140, a common electrode 151, and a front alignment film 161, which are laminated one on the other and disposed in that order from top to bottom. The front polarizer 171 and the front compensation member 180 are disposed on an outer surface of the first glass substrate 110, in that order from top to bottom. The front alignment film 161, the common electrode 151 and the color filter 140 are disposed on an inner surface of the first glass substrate 110, in that order from bottom to top.

The second substrate assembly 102 includes a rear alignment film 162, a pixel electrode 152, a second glass substrate 120, a rear compensation member 190, and a rear polarizer 172, which are laminated one on the other and disposed in that order from top to bottom. In addition, in a typical application, a backlight module (not shown) is provided under the rear polarizer 172.

The liquid crystal layer 130, the common electrode 151, and the pixel electrode 152 cooperatively define a pixel region. When a voltage is applied to the transmission LCD 100, an electric field is generated between the common electrode 151 and the pixel electrode 152. The electric field can control the orientation of liquid crystal molecules (not labeled) in the liquid crystal layer 130 in order to display images.

In assembly, the liquid crystal molecules are bend-aligned to enable the transmission LCD 100 to operate in an optically compensated bend (OCB) mode. A pretilt angle of the liquid crystal molecules adjacent to the substrate assemblies 101 and 102 is in a range of 0° to 15°. An absorption axis of the front polarizer 171 maintains an angle of 45 degrees relative to the orientation direction of the liquid crystal molecules in the liquid crystal layer 130, and the absorption axis of the front polarizer 171 is orthogonal to an absorption axis of the rear polarizer 172.

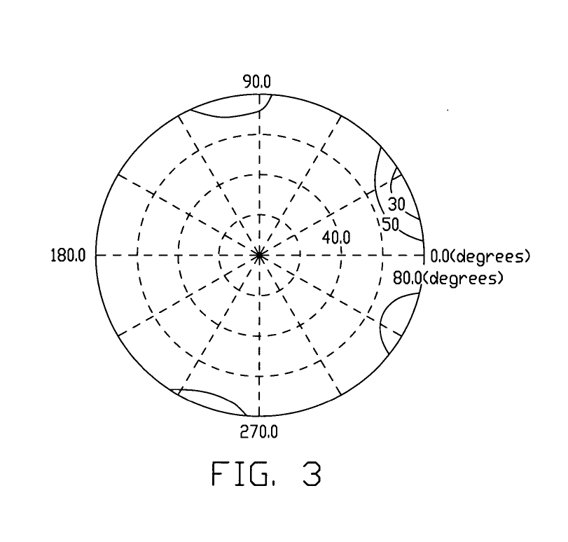

FIG. 2 is a schematic, exploded, side cross-sectional view of a transmission LCD 200 according to a second preferred embodiment of the present invention. The transmission LCD 200 is similar to the transmission LCD 100 of FIG. 1. However, a front compensation member 280 of the transmission LCD 200 includes a first front compensation film 281 and a second front compensation film 282. The first front compensation film 281 and the second front compensation film 282 are disposed on an outer surface of a first glass substrate 210, in that order from bottom to top. A rear compensation member 290 of the transmission LCD 200 includes a first rear compensation film 291 and a second rear compensation film 292. The first rear compensation film 291 and the second rear compensation film 292 are disposed on an outer surface of a second glass substrate 220, in that order from top to bottom. A rear polarizer 272 is disposed on a bottom of the second rear compensation film 292.

The first front and rear compensation films 281, 291 are hybrid C-plate compensation films, each of which is made from a uniaxial crystal. The second front compensation film 282 is a biaxial compensation film, which is made from a biaxial material. The second rear compensation film 292 is a C-plate compensation film, which is made from a uniaxial material. A slow axis of the second front compensation film 282 is parallel to an absorption axis of the rear polarizer 272.

In each pixel region of the transmission LCD 200, the liquid crystal molecules (not labeled) have a pre-tilt angle, which ensures that the liquid crystal molecules can more easily adjust their orientation when a voltage is applied to the transmission LCD 200 and a change in a driving electric field is effected. Thereby, the transmission LCD 200 has a fast response time. Moreover, the compensation films are used for compensating for phase delay produced by the liquid crystal molecules, so as to ensure that the transmission LCD 200 has improved contrast and viewing angle characteristics and displays good quality images.

FIG. 3 is a computer simulation contrast ratio graph for the transmission LCD 200 when light having a predetermined wavelength is utilized. As shown in FIG. 3, a 30:1 contrast ratio curve extends horizontally along the 0° vertical viewing axis a total of more than 150°, and a 50:1 contrast ratio curve extends vertically along the 0° horizontal viewing axis a total of more than 150°, which shows that a large viewing angle is obtained.

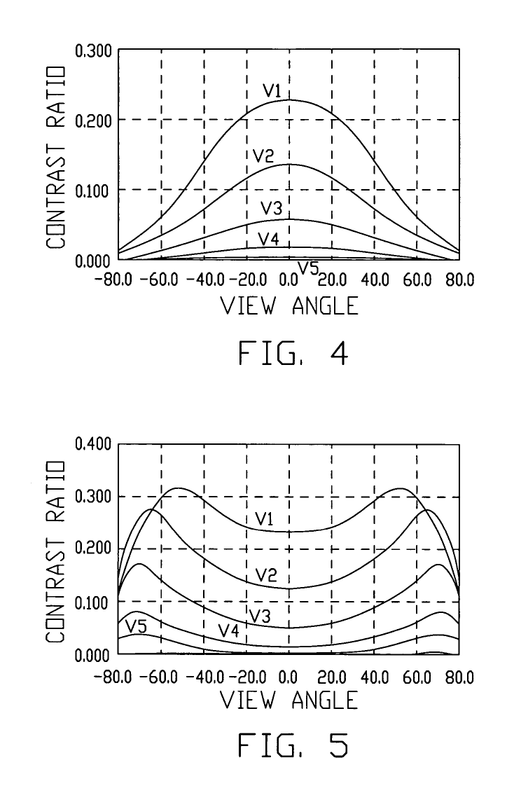

FIG. 4 and FIG. 5 illustrate gray scale performance along a horizontal direction and a vertical direction of the transmission LCD 200, respectively, when different voltages are applied. In FIG. 4 and FIG. 5, curve V1 represents a voltage of 1.5V applied, curve V2 represents a voltage of 2V applied, curve V3 represents a voltage of 3V applied, curve V4 represents a voltage of 4V applied, and curve V5 represents a voltage of 7V applied. As shown in FIG. 4 and FIG. 5, no gray scale inversion is produced along a horizontal direction along the 0° vertical viewing axis from -80° to 80°.

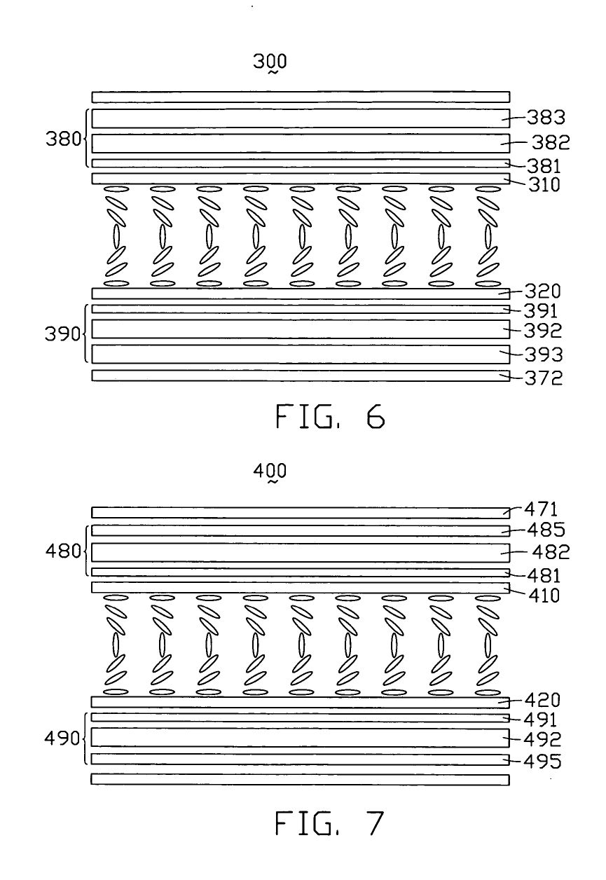

FIG. 6 is a schematic, exploded, side cross-sectional view of a transmission LCD 300 according to a third preferred embodiment of the present invention. The transmission LCD 300 is similar to the transmission LCD 200 of FIG. 2. However, a front compensation member 380 of the transmission LCD 300 includes a first front compensation film 381, a second front compensation film 382, and a third front compensation film 383. The first front compensation film 381, the second front compensation film 382, and the third front compensation film 383 are disposed on an outer surface of a first glass substrate 310, in that order from bottom to top. A rear compensation member 390 of the transmission LCD 300 includes a first rear compensation film 391, a second rear compensation film 392, and a third rear compensation film 393. The first rear compensation film 391, the second rear compensation film 392, and the third rear compensation film 393 are disposed on an outer surface of a second glass substrate 320, in that order from top to bottom. A rear polarizer 372 is disposed on a bottom of the third rear compensation film 393.

The first front and rear compensation films 381, 391 are hybrid C-plate compensation films. The second front and rear compensation films 382, 392 are C-plate compensation films. The third front and rear compensation films 383, 393 are A-plate compensation films, each of which is made from a uniaxial material. A slow axis of the third front compensation film 383 and a slow axis of the third rear compensation film 393 are parallel to an absorption axis of the rear polarizer 372, respectively.

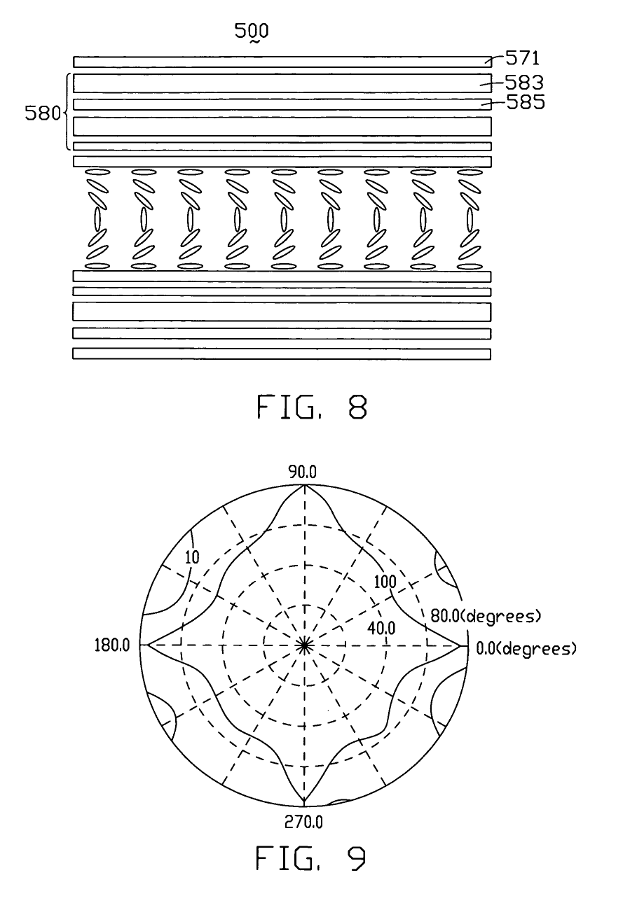

FIG. 7 is a schematic, exploded, side cross-sectional view of a transmission LCD 400 according to a fourth preferred embodiment of the present invention. The transmission LCD 400 is similar to the transmission LCD 200 of FIG. 2. However, a front compensation member 480 of the transmission LCD 400 includes a first front compensation film 481, a second front compensation film 482, and a front retardation film 485. The first front compensation film 481, the second front compensation film 482, and the front retardation film 485 are disposed on an outer surface of a first glass substrate 410, in that order from bottom to top. A front polarizer 471 is disposed on top of the front retardation film 485. A rear compensation member 490 of the transmission LCD 400 includes a first rear compensation film 491, a second rear compensation film 492, and a rear retardation film 495. The first rear compensation film 491, the second rear compensation film 492, and the rear retardation film 495 are disposed on an outer surface of a second glass substrate 420, in that order from top to bottom.

The first front and rear compensation films 481, 491 are hybrid C-plate compensation films. The second front and rear compensation films 482, 492 are C-plate compensation films. The front and rear retardation films 485, 495 are quarter-wave plates. A slow axis of the front retardation film 485 maintains an angle of 45 degrees relative to an absorption axis of the front polarizer 471, and the slow axis of the front retardation film 485 is orthogonal to a slow axis of the rear retardation film 495.

FIG. 8 is a schematic, exploded, side cross-sectional view of a transmission LCD 500 according to a fifth preferred embodiment of the present invention. The transmission LCD 500 is similar to the transmission LCD 400 of FIG. 7. However, a front compensation member 580 of the transmission LCD 500 further includes a third front compensation film 583 disposed between a front retardation film 585 and a front polarizer 571. The third front compensation film 583 is an A-plate compensation film. A slow axis of the third front compensation film 583 is orthogonal to an absorption axis of the front polarizer 571.

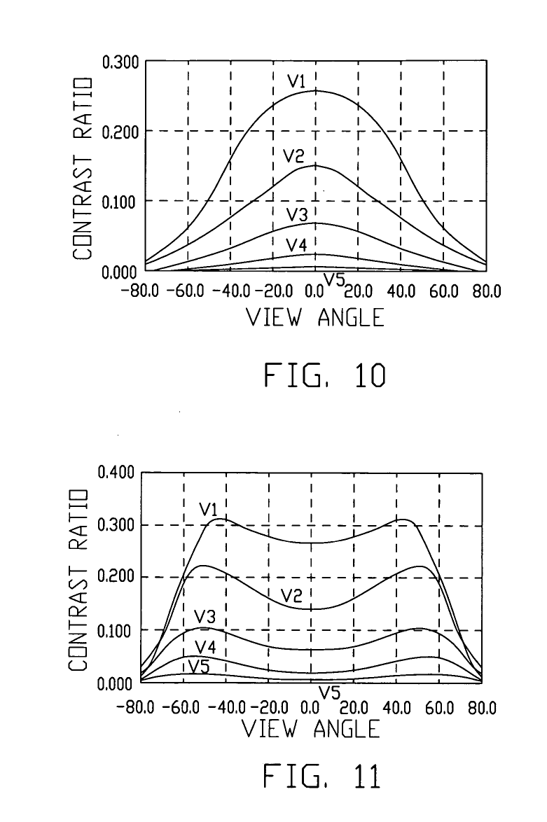

FIG. 9 is a computer simulation contrast ratio graph for the transmission LCD 500 when light having a predetermined wavelength is utilized. As shown in FIG. 9, a 30:1 contrast ratio curve extends horizontally along the 0° vertical viewing axis a total of more than 150°, and a 50:1 contrast ratio curve extends vertically along the 0° horizontal viewing axis a total of more than 150°, which shows that a large viewing angle is obtained.

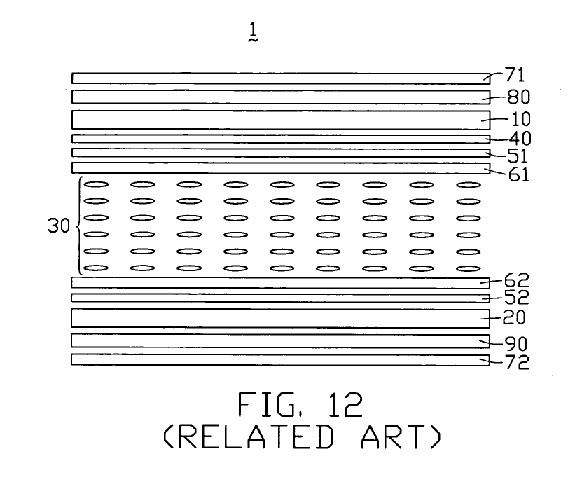

FIG. 10 and FIG. 11 illustrate gray scale performance along a horizontal direction and a vertical direction of the transmission LCD 500, respectively, when different voltages are applied. In FIG. 10 and FIG. 11, curve V1 represents a voltage of 1.5V applied, curve V2 represents a voltage of 2V applied, curve V3 represents a voltage of 3V applied, curve V4 represents a voltage of 4V applied, and curve V5 represents a voltage of 7V applied. As shown in FIG. 10 and FIG. 11, no gray scale inversion is produced along a horizontal direction along the 0° vertical viewing axis from -800 to 800.

In each pixel region of each of the above-described transmission LCDs, the liquid crystal molecules have a pre-tilt angle, which ensures that the liquid crystal molecules can more easily adjust their orientation when a voltage is applied to the transmission LCD and a change in a driving electric field is effected. Thereby, the transmission LCDs have a fast response time. Moreover, the retardation films and the compensation films are used for compensating for color, so as to ensure that the transmission LCDs have improved contrast and viewing angle characteristics and display good quality images.

It is to be understood, however, that even though numerous characteristics and advantages of various embodiments have been set forth in the foregoing description, together with details of the structures and functions of the embodiments, the disclosure is illustrative only, and changes may be made in detail to the full extent indicated by the broad general meaning of the terms in which the appended claims are expressed.

What is claimed is:

1. A transmission liquid crystal display, comprising:
a first substrate and a second substrate;
a liquid crystal layer having liquid crystal molecules interposed between the first and second substrates, the liquid crystal molecules being bend-aligned whereby the liquid crystal display device operates in an optically compensated bend (OCB) mode;
a front polarizer disposed at an front surface of the first substrate, and a rear polarizer disposed at a rear surface of the second substrate;
a first compensation member between the front polarizer and the first substrate; and
a second compensation member between the rear polarizer and the second substrate.

2. The transmission liquid crystal display as claimed in claim 1, wherein a pretilt angle of liquid crystal molecules adjacent to the first and second substrates is in a range of 0° to 15°.

3. The transmission liquid crystal display as claimed in claim 2, wherein an absorption axis of the front polarizer maintains an angle of 45 degrees relative to an alignment direction of the liquid crystal molecules, and the absorption axis of the front polarizer is substantially orthogonal to an absorption axis of the rear polarizer.

4. The transmission liquid crystal display as claimed in claim 1, wherein the first compensation member comprises a first front compensation film and a second front compensation film, the first front compensation film is disposed at a front surface of the first substrate, the second front compensation film is disposed at a front surface of the first front compensation film, and the first front compensation film is a hybrid C-compensation film.

5. The transmission liquid crystal display as claimed in claim 4, wherein the second compensation member comprises a first rear compensation film and a second rear compensation film, the first rear compensation film is disposed at arear surface of the second substrate, the second rear compensation film is disposed at arear surface of the first rear compensation film, and the first rear compensation film is a hybrid C-compensation film.

6. The transmission liquid crystal display as claimed in claim 5, wherein the second front compensation film is a biaxial compensation film.

7. The transmission liquid crystal display as claimed in claim 6, wherein a slow axis of the second front compensation film is parallel to an absorption axis of the rear polarizer.

8. The transmission liquid crystal display as claimed in claim 5, wherein the first compensation member further comprises a third front compensation film disposed between the second front compensation film and the front polarizer.

9. The transmission liquid crystal display as claimed in claim 8, wherein the second compensation member further comprises a third rear compensation film disposed between the second rear compensation film and the rear polarizer.

10. The transmission liquid crystal display as claimed in claim 9, wherein the second front and rear compensation films are C-plate compensation films, and the third front and rear compensation films are A-plate compensation films.

11. The transmission liquid crystal display as claimed in claim 10, wherein the third front and rear compensation films are substantially parallel to an absorption axis of the rear polarizer.

12. The transmission liquid crystal display as claimed in claim 5, wherein the first compensation member further comprises a front retardation film disposed between the second front compensation film and the front polarizer.

13. The transmission liquid crystal display as claimed in claim 12, wherein the second compensation member further comprises a rear retardation film disposed between the second rear compensation film and the rear polarizer.

14. The transmission liquid crystal display as claimed in claim 13, wherein the second front and rear compensation films are C-plate compensation films, and the front and rear retardation films are quarter-wavelength plates.

15. The transmission liquid crystal display as claimed in claim 14, wherein the first front retardation film maintains an angle of 45 degrees relative to an absorption axis of the front polarizer.

16. The transmission liquid crystal display as claimed in claim 12, wherein the first compensation member further comprises a third front compensation film disposed between the front retardation film and the front polarizer.

17. The transmission liquid crystal display as claimed in claim 16, wherein the third front compensation film is an A-plate compensation film, and a slow axis of the third front compensation film is orthogonal to an absorption axis of the front polarizer.

18. A method of making a transmission liquid crystal display, comprising steps of:
providing a first substrate and a second substrate;
providing a liquid crystal layer having liquid crystal molecules interposed between the first and second substrates, the liquid crystal molecules being bend-aligned whereby the liquid crystal display device operates in an optically compensated bend (OCB) mode;
providing a front polarizer disposed at an front surface of the first substrate, and a rear polarizer disposed at a rear surface of the second substrate;
providing a first compensation member between the front polarizer and the first substrate; and
providing a second compensation member between the rear polarizer and the second substrate.
